(19) United States
(12) Patent Application Publication
(10) Pub. No.: US 2004/0053100 A1
(43) Pub. Date: Mar. 18, 2004

(54) Method of fabricating fuel cells and membrane electrode assemblies

(76) Inventors: Kevin G. Stanley, Vancouver (CA); Eva K. Czyzewska, Coquitlam (CA); Thomas P. K. Vanderhoek, Vancouver (CA); Q. M. Jonathan Wu, Vancouver (CA); Terrance Y. H. Wong, Burnaby (CA)

Correspondence Address: Oyen Wiggs Green & Mutala, Suite 480--The Station, 601 West Cordova Street, Vancouver, V6B 1G1, CA

(21) Appl. No.: 10/454,484

(22) Filed: Jun. 5, 2003

Related U.S. Application Data
(60) Provisional application No. 60/410,001, filed on Sep. 12, 2002.

(51) Int. Cl. H01M 8/10; B05D 5/12; H01M 4/88

(52) U.S. Cl. 429/30; 427/115; 502/101; 429/38; 429/32

(57) ABSTRACT

The application relates to a method of fabricating micro fuel cells and membrane electrode assemblies by thin film deposition techniques using a dimensionally stable proton exchange membrane as a substrate. The application also relates to membrane electrode assemblies and fuel cells fabricated in accordance with the method. The method includes the steps of successively depositing catalyst, current collector and flow management layers on the membrane substrate in predetermined patterns. Since the fuel cell is formed layer by layer, the need for assembly and sealing of discrete components is avoided. The method improves the contact resistance between the current collectors and catalyst layers and reduce ohmic losses, thereby avoiding the need for end plates or other compressive elements. This in turn reduces the overall thickness of the manufactured fuel cell. Since the fuel cell layers are optionally flexible, the devices may be fabricated using a continuous roller process or other automated means. The method minimizes production costs and costs of non-essential materials and is particularly suitable for low power battery replacement applications.

### REFERENCE TO RELATED APPLICATION

This application claims the benefit of U.S. provisional patent application No. 60/410,001 filed Sep. 12, 2002.

### TECHNICAL FIELD

This application relates to a method of fabricating micro fuel cells and membrane electrode assemblies by thin film deposition techniques using a dimensionally stable proton exchange membrane as a substrate. The application also relates to membrane electrode assemblies and fuel cells fabricated in accordance with the method.

### BACKGROUND

Fuel cells are electrochemical devices that convert the chemical energy of a fuel (e.g. hydrogen or hydrocarbons) directly to electrical energy. They offer an environmentally friendly means to generate power with high efficiencies. They are modular in design and flexible with respect to size and fuel requirements. In general, a fuel cell functions by combining hydrogen and oxygen to form water, and the use of an electrode-electrolyte assembly ensures that this reaction is carried out electrochemically, without combustion, to generate electricity. A fuel cell generates a potential difference (i.e. electrical power) from two electrochemical half reactions, namely the oxidation of hydrogen at the anode and the reduction of oxygen at the cathode, to produce water. For a hydrogen fuel cell, the electrochemical half reactions are as follows:

Anode: H₂→2H⁺+2e⁻

Cathode: 0.5 O₂+2H⁺+2e⁻→H₂O

The net reaction is as follows:

Net: H₂+0.5 O₂→H₂O

Some fuel cells operate by directly oxidizing methanol at the anode to produce hydrogen ions and carbon dioxide. The mechanism for this reaction is not well understood; however, the net anode electrochemical reaction is as follows:

Anode: CH₃OH+H₂O→CO₂+6H⁺+6e⁻

Proton exchange membrane (PEM) fuel cells are characterized by an ion or proton conducting membrane separating the two half reactions. This membrane is permeable to positive ions, preferably protons only, and is impervious to liquids and gasses. The membrane catalyst and gas diffusion layers are collectively known as a membrane electrode assembly (MEA).

FIG. 1 illustrates a conventional PEM fuel cell 10 of the prior art comprising a MEA. Such fuel cells 10 are usually built around a polymer membrane 12 comprising a solid polymer electrolyte, such as Nafion® manufactured by Dupont. The fuel, usually hydrogen, flows through a top plate 14 which is commonly made from graphite or some other chemically inert material having the required electrical and heat conductivity characteristics. PEM fuel cells 10 have catalysts 16 at both the anode and cathode to enhance the reaction rate, usually platinum on activated carbon. Different platinum alloys have been investigated for reducing light hydrocarbons directly, increasing the reaction rate and alleviating sensitivity to contaminant gasses. A gas diffusion layer 18 consisting of a carbon cloth is typically provided to better distribute the fuel and oxidant across the catalyst 16 and to conduct electrons. Seals 19 are typically provided at the end portions of the fuel cell assembly.

Significant public and private sector research has been conducted recently on micro fuel cell development. Micro fuel cells are generally defined as fuel cells producing less than 100 W of power, intended for portable applications. Typical portable electronics applications include laptop computers, cellular phones, hand-held communicators, pagers, video recorders, and portable power tools. Portable power devices are also becoming increasingly common in military and medical applications. For example, devices such as radios, navigation aids, night vision goggles and air conditioned protective suits require reliable portable power supplies. Embedded electronic devices such as pacemakers and diagnostic sensors may also potentially be powered by micro fuel cells. Microelectromechanical system (MEMS) devices are another area of active research which demand the development of smaller, lighter and longer lasting power sources.

If traditional fuel cells can be reduced in size and cost, then they could potentially compete with lithium ion batteries for use in such portable power applications. In terms of power density, a micro fuel cell can provide between 6 and 7 times the energy per unit mass as lithium ion batteries. For example, in cellular phone applications, the talk time of a cellular phone using a lithium ion battery is typically between 4 to 5 hours whereas a micro fuel cell would enable approximately 17-27 hours of talk time. The use of methanol as a fuel supply would also enable instant recharging whereas recharging conventional lithium ion batteries typically requires several hours. Further, direct methanol fuel cells are particularly suitable for portable power applications because of the high volumetric energy density of methanol.

Fuel cells are traditionally manufactured in a step-by-step fashion and then assembled from discrete components. This assembly is difficult since many of the component parts are not rigid and require complex sealing regimes which are prone to failure. The assembly process increases the complexity and reduces the reliability of fuel cell products. Particular problems arise in the fabrication of micro fuel cells. Most micro fuel cell fabrication processes employ traditional serial machining techniques, which are expensive to miniaturize, or MEMS techniques which are inherently batch processes and require expensive vacuum based steps. These processes dramatically increase the cost of the fuel cell system and make competition with established solutions like lithium ion batteries unlikely.

U.S. Patent Publication No. 2002/0076589 A1, Bostaph et al., dated Jun. 20, 2002 exemplifies prior art micro fuel cell designs which require substantial assembly. While fluid and electron flow are controlled by micromachined structures in the Bostaph et al. design, the MEA is a discrete component having a conventional configuration.

Published PCT application No. WO 02/41433, Ren et al., dated May 23, 2002, similarly describes a micro fuel cell design requiring extensive assembly. The Ren et al. fuel cell employs methanol fuel and is designed for low power battery replacement applications. In this invention the MEA is formed by applying anode and cathode ink directly on a polymer proton conducting membrane.

U.S. Pat. No. 5,759,712, Hockaday, dated Jun. 2, 1998, describes a miniature fuel cell system using porous plastic membranes as substrates for fuel cells. The fuel cells may be deployed in a flexible membrane package that may be wrapped around a protective container or the like. Hockoday has also described systems using vapor deposition techniques for depositing catalyst film layers on a central membrane. The Hockaday fuel cell system of the '712 patent does, however, employ seals requiring some mechanical compression.

Some other methods are known in the prior art for fabricating micro fuel cells or components thereof using deposition rather than assembly steps. Published PCT application No. WO 00/45457, Janowski et al., dated Aug. 3, 2000 describes a MEMS-based compact fuel cell fabricated by thin film deposition technologies. In one embodiment a MEA laminate structure is attached, bonded or mechanically sealed to a micromachined manifold host structure.

U.S. Patent Publication No. US 2002/0045082 A1, Marsh, dated Apr. 18, 2002, relates to a miniature fuel based power source. According to the Marsh fuel cell topology, a wide channel is etched into a substrate and the MEA is formed in a central column within the channel by successive deposition of a proton conducting material.

European patent application EP 1 078 408 B1, Dong, describes a fuel cell flow field structure formed by layered deposition. Dong describes the use of silk-screening techniques to build-up channels for flow fields on a substrate, such as an ion-exchange membrane. Deposition may be effected by screen-printing machines in a production line arrangement. Dong, however, focuses on the manufacture of electrochemical fuel cell strata or plates in which are formed flow field channels and does not describe the formation of an integrated fuel cell having current collectors directly deposited on a membrane substrate.

While significant advances have been made in micro fuel cell fabrication techniques, most prior art systems exhibit one or more of the following drawbacks:

Assembly: As component parts become smaller, they usually become more difficult to manipulate and their functional effectiveness may also be reduced, as is the case with miniature gaskets. Mating rigid ceramic or silicon-based components with flexible components is a difficult task by hand, and is extremely difficult to automate. These problems are exacerbated at small scales.

Sealing: Manipulating small gaskets poses extreme technical problems. Managing the appropriate balance between over-compressing the gaskets and providing sufficient compression to minimize the contact resistance between the electrodes and bulk current collecting plate is very difficult to achieve, especially with brittle materials such as silicon or graphite. Some designs have opted for adhesive based sealing rather than gasket based sealing. However, controlling the distribution of adhesive is difficult.

Size: If compression is required for either sealing or minimizing contact resistance, endplates or similar compressive elements will be required. Such compressive elements add a significant amount of weight and bulk for no gain in active area.

Material Cost While costs associated with noble metal catalysts and patented polymer ion conductors are unavoidable, costs associated with graphite, silicon and other favored substrates are. Reducing or eliminating the need for use of such materials in flow fields and bi-polar plates, for example, can result in significant cost savings.

The need has therefore arisen for an improved method for economically fabricating fuel cells and MEA devices without assembly using thin film deposition techniques.

### SUMMARY OF INVENTION

The present invention overcomes the limitations of conventional fuel cell fabrication processes by enabling fuel cells and MEAs to be fabricated in a continuous process without assembly. The method minimizes production costs and costs of non-essential materials. In accordance with the invention, a proton exchange membrane is used as a substrate and layers of catalyst, current collector and flow management channels are successively deposited on the substrate. By building up the fuel cell from a stable substrate, the following advantages can be achieved:

1. Contact resistance between the bulk current collectors and catalyst becomes negligible.

2. Assembly of discrete pieces is no longer required, increasing the automatibility of the system.

3. Sealing is achieved inherently, removing the need for gaskets and compression.

4. End-plates are not required reducing the thickness of the fuel cell by an order of magnitude.

5. Because all of the components are preferably flexible, the fuel cell is more durable, and can be optionally fabricated using a continuous roller process.

6. Non-essential component costs are reduced to a minimum.

Applicant's fuel cell fabrication method generally involves four steps: membrane preparation, catalyst deposition, current collector deposition and flow field formation. The method eliminates the need for a MEA gas diffusion layer and requires no compression for either sealing or minimizing contact resistance. While micromachining techniques may be used to fabricate molds, jigs and templates used in conjunction with the invention, the fabrication method itself is more akin to high speed printing, decreasing production costs and increasing throughput. The result is a smaller, less expensive, easily manufactured fuel cells and MEA components suitable for low power battery replacement applications.

According to one embodiment of the invention the method includes the steps of providing a dimensionally stable membrane having a first surface and a second surface; depositing a first catalyst layer on the first surface according to a first predetermined pattern; and depositing a first current collector layer on the first surface according to a second predetermined pattern. Preferably the catalyst layer and the current collector layer are aligned so that they are in contact with one another on the membrane. Both the catalyst layer and the current collector layer may be applied to the membrane in a generally common plane of deposition.

The catalyst layer may be subdivided according to the first predetermined pattern into a plurality of discrete catalyst regions. The current collector layer may also be subdivided according to the second predetermined pattern into a plurality of discrete conductive regions. Preferably the conductive regions are formed immediately adjacent the catalyst regions on the membrane. Each of the conductive regions comprises a distinct electrode and such electrodes may be electrically connected together in series or parallel.

The method may further include the steps of depositing a second catalyst layer on the second surface of the membrane according to the first predetermined pattern and depositing a second current collector layer on the second surface of the membrane according to the second predetermined pattern. The first predetermined pattern on the first surface of the membrane is preferably aligned with the first predetermined pattern on the second surface of the membrane, and the second predetermined pattern on the first surface of the membrane is likewise aligned with the second predetermined pattern on the second surface of the membrane.

The dimensionally stable membrane may constitute a proton exchange membrane. The membrane may be formed by providing a porous substrate composed of an inert material, such as glass, polytetrafluoroethylene, polyethylene, and/or polypropylene, and impregnating the substrate with an ionomer, such as Nafion®.

The step of depositing the catalyst layer on the first surface according to the first predetermined pattern may include providing a first template having openings corresponding to the first predetermined pattern; temporarily coupling the first template to the membrane; and spraying a catalyst through the openings in the first template to deposit the catalyst on the membrane in the first predetermined pattern. The template may be temporarily coupled to the membrane during the spraying process by interposing the membrane between the first template and a magnet, for example. Alternatively, the catalyst may be deposited and/or patterned on the membrane by other means, such as microspraying, photolithography, printing or other direct mechanical application. The membrane electrode assembly may then be subjected to one or more hot pressing steps.

The step of depositing the current collector layer on the first surface according to the second predetermined pattern may also be accomplished by various means including printing, stamping, spraying, photolithography and the like. In particular embodiments the current collector layer comprises a sputtered gold film or a conductive polymer.

The fuel cell may be manufactured by fabricating a membrane electrode assembly as described above and further forming a first flow field layer on the membrane according to a third predetermined pattern, wherein at least a portion of the flow field layer is bonded to the membrane. The flow field layer may be deposited by applying a curable epoxy, such as SU-8, to the membrane and allowing the epoxy to cure in the third predetermined pattern. The flow field layer includes a plurality of flow field channels formed adjacent the catalyst regions. Further, at least a portion of the flow field layer may overlap the conductive regions. The flow field layer may alternatively be pre-formed in the third predetermined pattern, such as casting the layer on a mold, and then adhering the layer to the membrane, for example by using silicone rubber.

In an alternative embodiment of the invention, a fuel cell may be fabricated by forming first and second membrane electrode assemblies as described above and annealing the second surface of the first membrane assembly to the second surface of the second membrane assembly. The second surfaces may optionally be coated with Nafion® prior to the annealing step.

The application also relates to membrane electrode assemblies, fuel cells and fuel cell stacks fabricated according to the above method. Preferably such devices are flexible and have a thickness not exceeding 1 mm in the case of membrane electrode assemblies and 5 mm in the case of micro fuel cells, including the flow field layer.

### BRIEF DESCRIPTION OF DRAWINGS

In drawings which describe embodiments of the invention but which should not be construed as restricting the spirit or scope thereof,

FIG. 1 is a cross-sectional view of a conventional PEM fuel cell of the prior art.

FIG. 2(a) is a cross-sectional view of a dimensionally stable PEM membrane used as a substrate for fuel cell fabrication in accordance with the invention.

FIG. 2(b) is a cross-sectional view of the membrane of FIG. 2(a) with a catalyst layer deposited thereon.

FIG. 2(c) is a cross-sectional view of the membrane of FIG. 2(b) with a bulk current collector layer deposited thereon.

FIG. 2(d) is a cross-sectional view of the membrane of FIG. 2(c) with flow field layer posts deposited thereon.

FIG. 2(e) is a cross-sectional view showing a cap applied to the posts of FIG. 2(d) to cap the flow field layer on the anode side of the membrane.

FIG. 2(f) is a cross-sectional view of an alternative embodiment of the invention showing a pre-formed flow field layer bonded to the membrane substrate.

FIG. 2(g) is a fuel cell stack comprising a pair of micro fuel cells as shown in FIG. 2(f).

FIG. 3(a) is a plan view of a membrane electrode assembly fabricated in accordance with the invention comprising co-planar catalyst and bulk current collector layers deposited on a PEM membrane substrate.

FIG. 3(b) is a plan view of the catalyst layer of FIG. 3(a)

FIG. 3(c) is a plan view of the current collector layer of FIG. 3(a)

FIG. 3(d) is an isometric view of a micro fuel cell comprising a membrane electrode assembly and a flow field layer.

FIG. 4(a) is a plan view of an alternative embodiment of a membrane electrode assembly fabricated in accordance with the invention comprising co-planar catalyst and bulk current collector layers deposited on a PEM membrane substrate.

FIG. 4(b) is a plan view of the catalyst layer of FIG. 4(a).

FIG. 4(c) is a plan view of the current collector layer of FIG. 4(a).

FIG. 5(a) is an exploded view of a template and magnet assembly for applying a catalyst layer pattern on to a membrane substrate interposed therebetween

FIG. 5(b) is an exploded view of a template and magnet assembly for applying a current conductor layer pattern on to a membrane substrate interposed therebetween.

FIG. 6 is an isometric view of a mold for producing a pre-formed flow field layer.

FIG. 7 is a graph showing polarization and power data for a fuel cell fabricated in accordance with one embodiment the invention.

FIG. 8 is a graph showing polarization and power output data for a fuel cell fabricated in accordance with a second embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

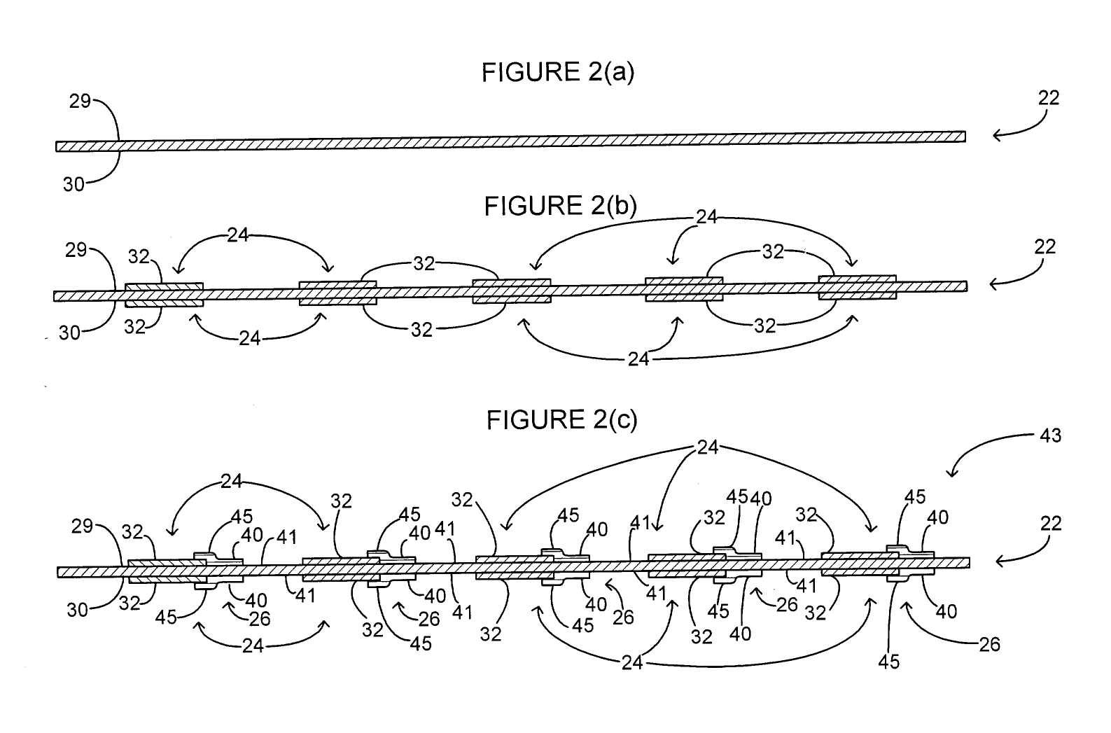

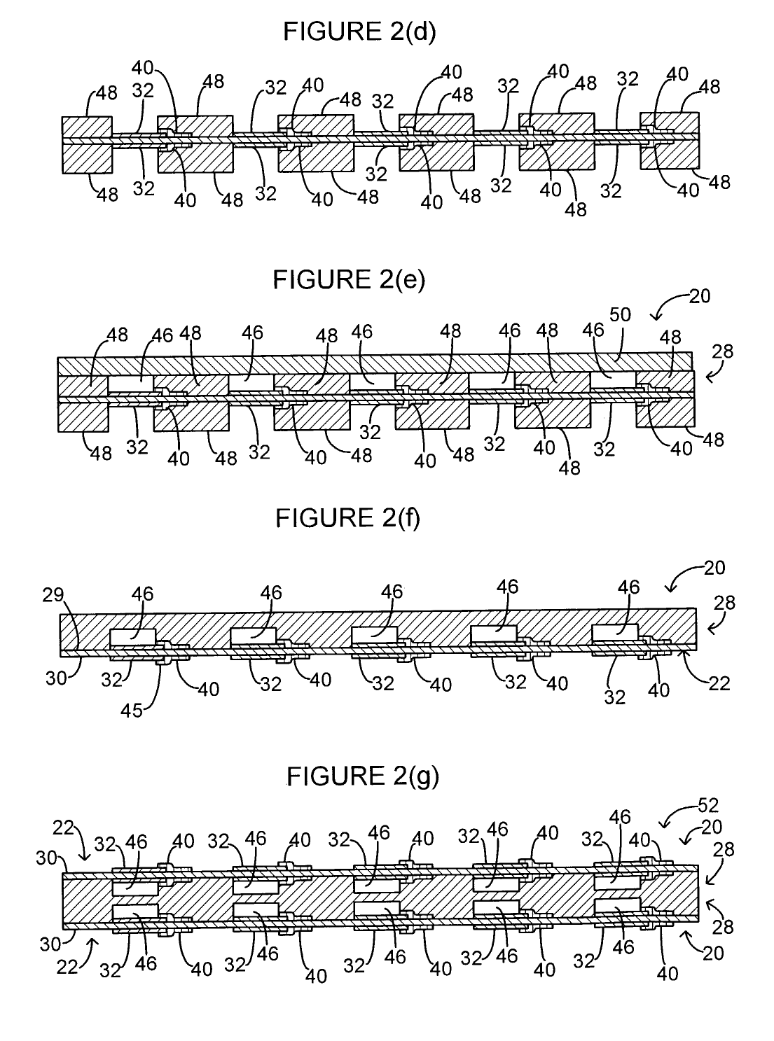

FIGS. 2(a)-2(f) illustrate Applicant's method for fabricating fuel cells 20 using thin film deposition techniques. As described below, the fabrication method may be automated in a continuous process to reduce fuel cell production costs. The method employs a dimensionally stable proton exchange membrane 22 as a substrate for receiving successive layers of material, namely a catalyst layer 24, a current collector layer 26 and a flow field layer 28. The method enables the production in an assembly-less fashion of very thin fuel cells 20 suitable for micro power applications.

The first step in the Applicant's method is to provide a membrane 22 as shown in FIG. 2(a) composed of a solid proton or oxide conducting material or combination of materials. Membrane 22 has a first exposed surface 29 and a second exposed surface 30. Since membrane 22 is used as a substrate for deposition of layers 24-26, it must be dimensionally stable over the range of chemical exposure and operating temperatures expected for a fuel cell. As used in this patent specification “dimensionally stable” means that membrane 22 is mechanically robust and will not substantially expand or contract, such as when hydrated or dehydrated. Suitable dimensionally stable membranes may be composed, for example, of ceramics, polymers, plastics and supported composite membranes, or combinations thereof, and may include flexible materials.

PEM fuel cells typically employ a solid polymer electrolyte such as Nafion® from DuPont or Flemion® from Asahi Glass Company, Limited. While such polymers provide good proton conductivity and ionic selectivity, they are not dimensionally stable, and expand and contract substantially when hydrated or dehydrated. This shortcoming may be overcome by impregnating the polymer within a stable substrate. In one embodiment of the invention, membrane 22 comprises a polymer electrolyte such as Nafion® supported within a porous glass network. Porous glass has the advantage that it is hydrophilic and therefore exhibits excellent polymer uptake characteristics.

As discussed further below, Nafion® ionomer or resin may be applied to a porous glass substrate through a droplet or spray. Alternatively the glass substrate may be immersed in Nafion® ionomer. Several coats or applications may be required to ensure membrane 22 is saturated with Nafion® and is devoid of pinholes. As will be apparent to a person skilled in the art, other means for forming a membrane 22 may also be employed, such as using threads or meshes pre-coated with Nafion®.

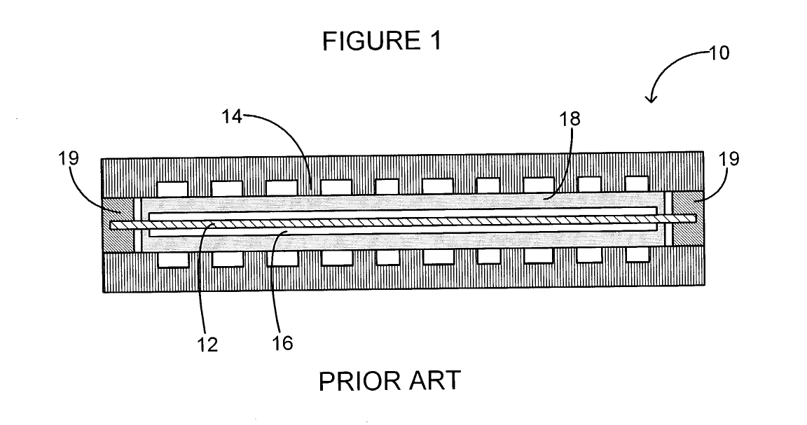

The next step in the Applicant's method is to apply catalyst layer 24 to membrane 22 according to a predetermined pattern. The patterned catalyst layer 24 is preferably applied to both first surface 29 (which will become the anode side of membrane 22) and second surface 30 (which will become the cathode side of membrane 22). Unlike the conventional prior art fuel cell of FIG. 1, catalyst layer 24 is applied directly to membrane 22 and no intervening gas diffusion layers are provided. Catalyst layer 24 forms a three-phase boundary with membrane 22 and provides the medium on which the fuel cell electrochemical reaction takes place. Catalyst layer 24 may consist of a conventional catalyst, such as platinum on carbon black.

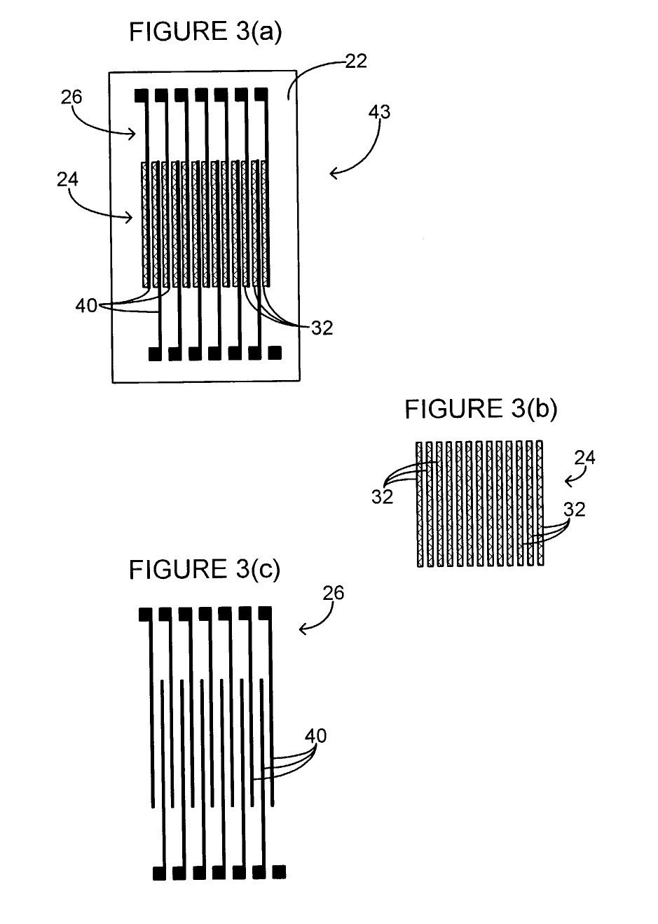

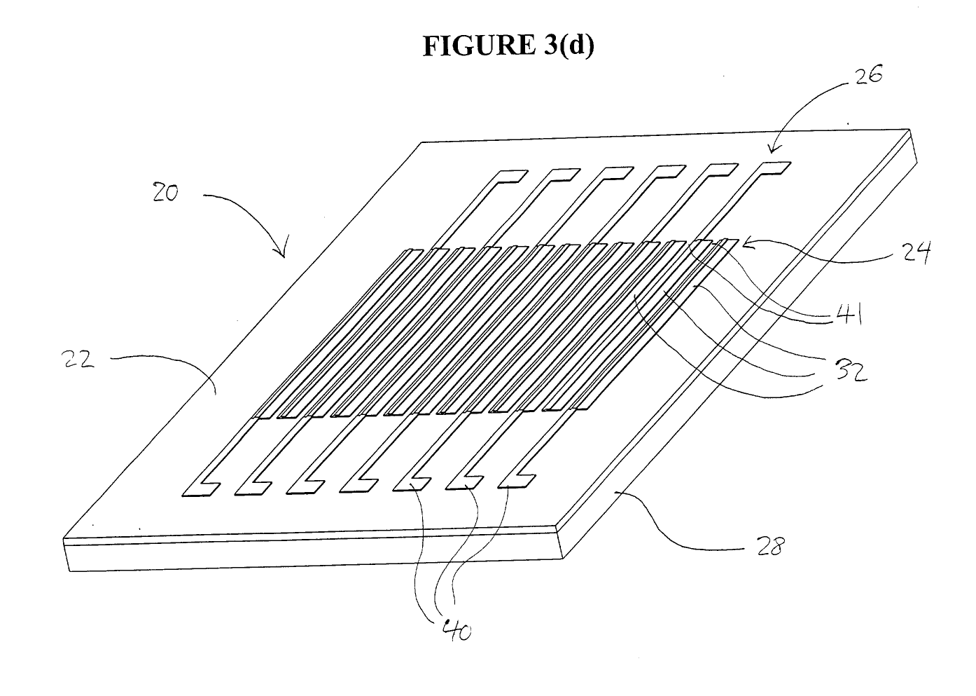

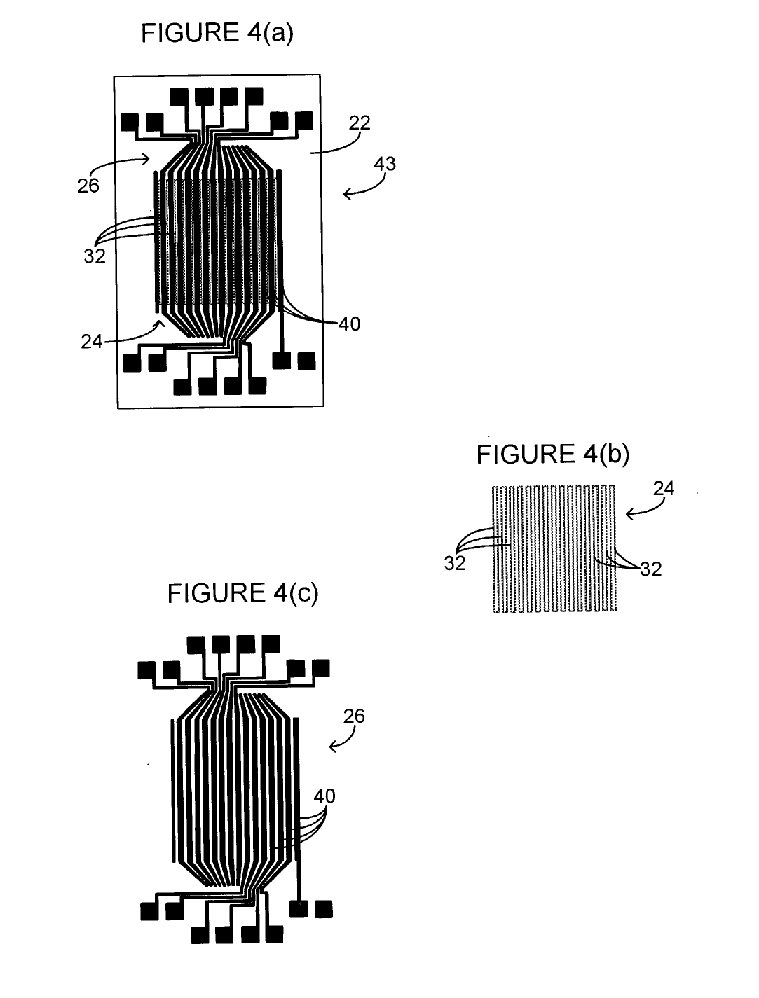

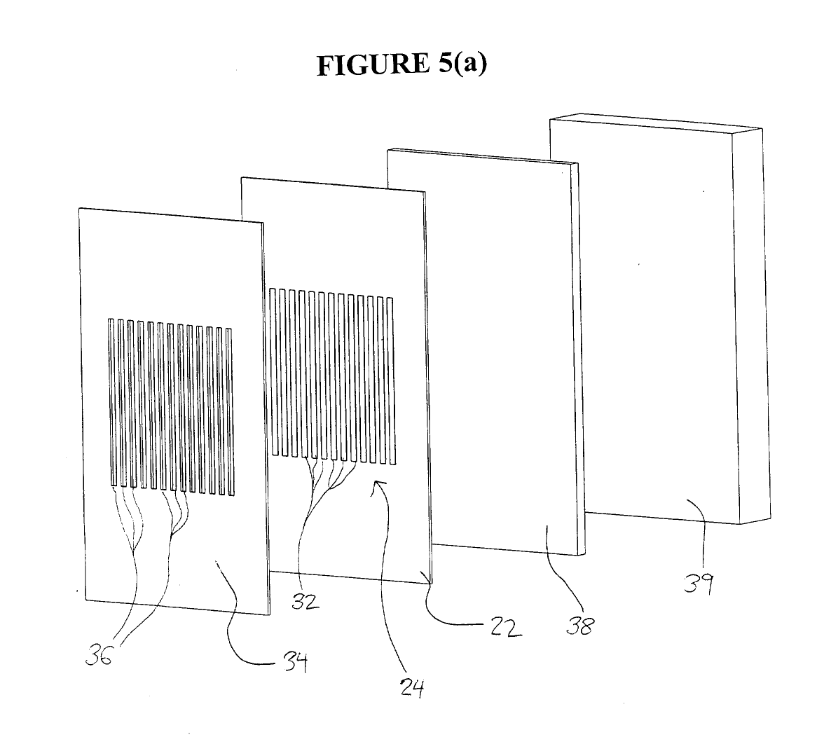

As shown in FIGS. 2(b) and 4, catalyst layer 24 may be applied to membrane 22 in a pattern consisting of a plurality of spaced-apart catalyst regions 32 to thereby generate a plurality of distinct electrodes. These electrodes may then be electrically connected in parallel to create a single cell with a high peak current, or in series to create several cells with high peak voltages (FIGS. 3(a) and 4(a)).

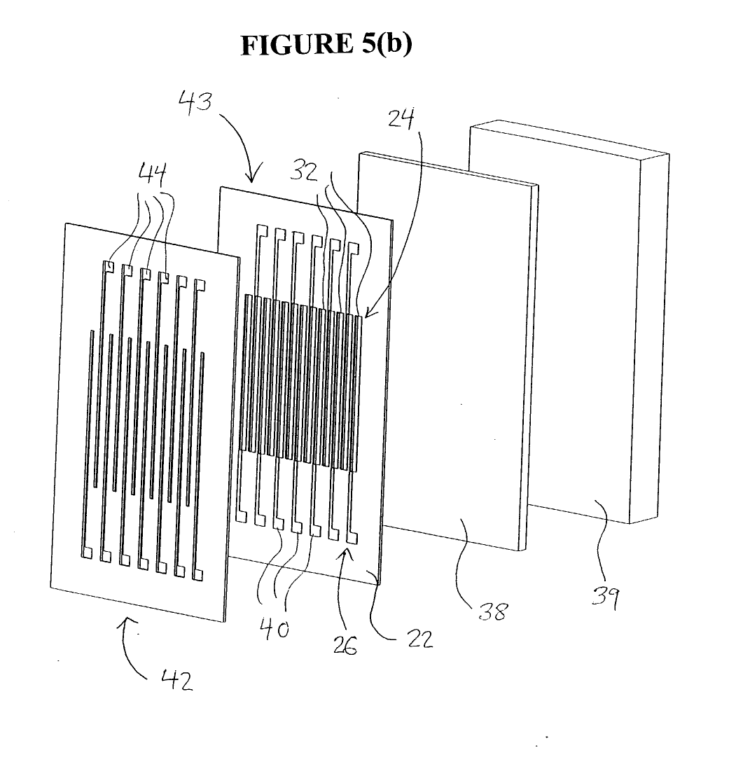

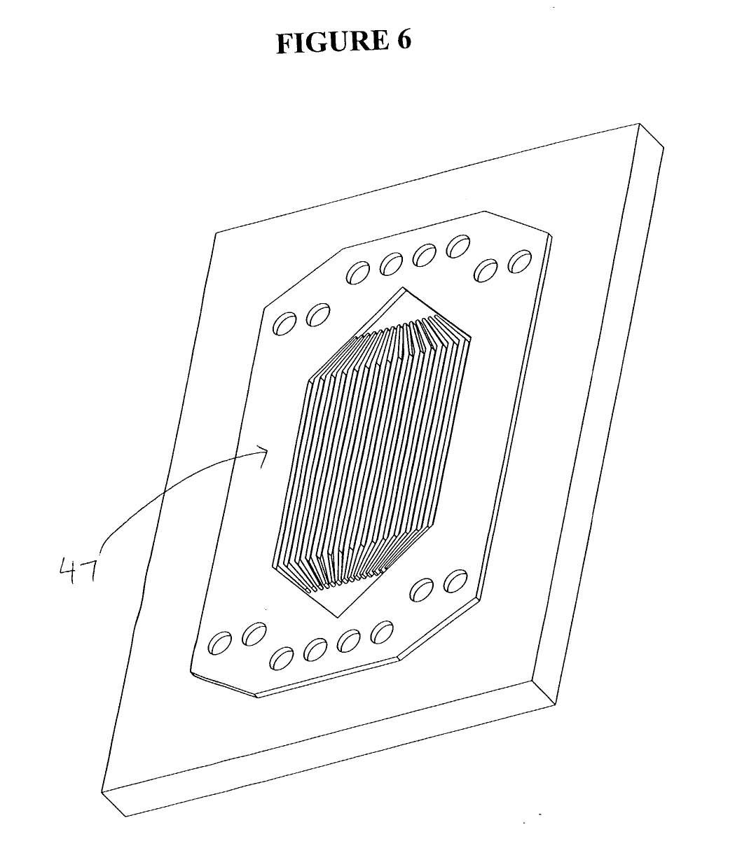

Catalyst regions 32 may comprise a plurality of spaced-apart lines or squares to facilitate in-plane current collection as described below. Various means may be employed to apply catalyst layer 24 on membrane 22 in the desired pattern, including spraying, printing, photolithography or mechanical application. FIG. 5(a) illustrates one possible means for spray depositing catalyst layer 24 on membrane 22 employing a mask or template 34. Template 34 includes a plurality of openings 36 configured in the pattern of regions 32. Template 34 may be formed from a metal such as steel or nickel and may be temporarily held in close contact relative to membrane 22 with a magnetic chuck comprising a magnet 38 and a steel base plate 39 (FIG. 5(a)). Catalyst may then be sprayed on template 34 using an airbrush operated with a compressed airstream. Catalyst passing through openings 36 forms the catalyst layer 24 on an exposed surface 29, 30 of membrane 22 in the desired pattern. Once the desired amount of catalyst is deposited, template 34 and membrane 22 are removed from magnet 38, membrane 22 is reversed and the spraying procedure is repeated on the opposite surface 29, 30 of membrane 22. Care must be taken to align template 34 and membrane 22 with respect to the catalyst pattern already deposited on the opposite surface 29, 30. This alignment may be achieved, for example, with the aid of a light table.

The next step in the fabrication procedure is to apply current collector layer 26 to membrane 22 as shown in FIG. 2(c) according to a predetermined pattern. Preferably current collector layer 26 is applied directly to membrane 22 in a pattern matching catalyst layer 24 so that both layers extend in the same plane in contact with one another. For example, current collecting layer 26 may be applied to membrane 22 in a pattern consisting of a plurality of spaced-apart bulk current collection regions 40 which are each disposed between or otherwise adjacent to catalyst regions 32 (FIGS. 2(c), 3(a) and 4(a)). Regions 40 are patterned so as to minimize the unused regions 41 on membrane 22 between current collection regions 40 and to facilitate linking in series or parallel. Thus the active area of membrane 22 is maximized while avoiding the potential for short circuits between adjacent electrodes. Further, in an alternative embodiment of the invention membrane 22 could be coated with an insulator in regions 41. In the embodiment illustrated in the drawings, a small portion 45 of each conducting region 40 may overlap a corresponding catalyst region 32 to ensure effective electrical conduction. Current collector layer 26 may be composed of any electrically conducting material which is temperature and chemically compatible with the fuel cell system, such as a sputtered gold or a conductive polymer.

Deposition of current collector layer 26 directly on membrane 22 avoids the prior art requirement for compression to reduce contact resistance between the current collectors and catalyst layers 24, 26. This allows for the fabrication of a much thinner fuel cell 20 in comparison with prior art designs. As with catalyst layer 24, various means may be employed to apply current collecting layer 26 on membrane 22 in the desired pattern, including spraying, printing, photolithography or mechanical application. One possible means for depositing layer 26 on membrane 22 is by using a sputtering process deposited through a metallic template 42 having a plurality of openings 44 (FIG. 5(b)). Templates 42 are fashioned in the same manner as templates 34 described above to provide a minimum reliable contact between layers 24 and 26 and a minimum thickness profile. Template 42 may be pre-aligned with coated membrane 22 under a microscope on a flat magnet 38. The assembly comprising magnet 38, membrane 22 and template 42 is then placed inside a sputter-coater (not shown) with a pre-loaded gold target. After the gold is deposited, membrane 22 is disassembled from template 42 and magnet 38 to reveal the current collection regions 40. The combination of membrane 22 and catalyst and current conductor layers 24, 26 comprises a novel membrane electrode assembly 43 (FIGS. 3(a) and 4(a)).

The cell electrodes may then be electrically connected in any parallel or series combination required for the application. Several fabrication techniques including soldering, conductive epoxies, wire bonding or further conductor deposition step(s) can be used to perform the necessary interconnections.

The final step in the fabrication procedure is to apply flow field layer 28 to membrane 22 and/or to catalyst and current collector layers 24, 26 deposited thereon. Flow field layer 28 may either be deposited on membrane 22 (FIGS. 2(d) and 2(e)) or may be preformed and adhered to membrane 22 with an adhesive (FIG. 2(f)). In either case, flow field layer 28 comprises at least one channel 46 for supplying fuel or other reactants to catalyst layer 24 and for removing reaction products therefrom. In the illustrated embodiment a plurality of channels 46 are shown which may be physically separated or in fluid communication, such as connected in a serpentine pattern. In the case of very small fuel cells 20 (e.g. watch battery size) a single small channel 46 could be provided.

Layer 28 may be formed from any material having suitable thermal and chemically stability for use in fuel cells, such as metals, ceramics, polymers and plastics. In one embodiment of the invention molded silicone rubber may be employed in view of its low cost, ease of manufacture and suitable thermal and chemical properties. Flow field layer 28 covers membrane 22 and confers mechanical support to fuel cell 20.

In a first embodiment of the invention illustrated in FIG. 2(d), flow field layer 28 is formed on membrane 22 by direct deposit of flow field posts 48 in regions overlapping current collector regions 40 generally between catalyst regions 32. For example, as described further below, flow field posts 48 may be formed directly on the membrane electrode assembly 43 by casting a high aspect UV curable epoxy, such as SU-8. The SU-8 is spun on membrane 22 at ˜700 rpm for 30 seconds. After a short period where the film is allowed to cool and relax, it is placed in an oven at 100° C. for approximately two hours. The film should be hard to the touch after cooling. The film is then exposed to UV light through an emulsion mask to pattern flow field posts 48. Areas exposed through the mask are cured. Posts 48 are positioned to leave the catalyst regions 32 undeveloped. The developed area could cover the current collectors 40, an insulating zone, or both, as mentioned above. The film is exposed four consecutive times for 45 seconds, with a 15 second break between exposures. The film is then baked again at 100° C. for 15 minutes. The film is developed in SU-8 developer at room temperature for approximately one hour with gentle agitation. The film is then cleaned with new developer.

As shown in FIG. 2(e), flow field posts 48 may be capped with an outer cap layer 50 on the anode side of membrane 22 for controlled reactant or product flow through channels 46, or optionally left uncapped on the cathode side of membrane 22 for air breathing operation (FIG. 3(d)). As is the case in respect of catalyst regions 32 and current collector regions 40 described above, the deposition and patterning of flow field regions 48 may be accomplished by injection molding, photolithography or mechanical means.

As an alternative to the step of FIG. 2(d), or in conjunction with it, a pre-formed flow field layer 28 may be formed which is secured to membrane 22 with an adhesive (FIG. 2(f)). Layer 28 may be pre-formed in a mold 47 (FIG. 6). Sealing layer 28 to membrane 22 could be accomplished using silicone rubber adhesive (which the inventors have determined bonds particularly well to Nafion®). Both membrane 22 and flow field layer 28 could be flexible to facilitate lamination of one to the other using rotating rollers or the like in an automated process to avoid the need for assembly. The pre-formed flow field layer 28 of FIG. 2(f) has the advantage that significant quantities of solvent are not required to develop layer 28 in the desired pattern.

As will be apparent to a person skilled in the art, multiple fuel cells 20 fabricated in accordance with the invention may be readily connected together as shown in FIG. 2(g) to form a fuel cell stack 52. For example, the capped anode surfaces of respective fuel cells 20 of FIG. 2(f) could be bonded together to form stack 52.

As mentioned above, the Applicant's fuel cell fabrication method may be optimized for mass production of micro fuel cells. Since membrane 22 and membrane electrode assembly 43 derived therefrom may be flexible, the fabrication method could implemented in a continuous fashion, such as by passing membrane 22 through sequential deposition, molding, patterning and/or embossing stations in a calendaring process akin to papermaking. Since the fuel cell 20 end product is also preferentially flexible, it may be formed into non-planar shapes for versatility of packaging. For example, fuel cell 20 could be formed in a tubular shape in which case catalyst and current collector layers 24, 26 would extend in a generally common cylindrical orientation rather than the generally common horizontal plane of FIG. 2(c). Other shapes and orientations could be readily envisaged by a person skilled in the art.

### EXAMPLES

The following examples will further illustrate the invention in greater detail, although it will be appreciated that the invention is not limited to the specific examples.

Membrane formation

Both porous glass and Teflon® supported Nafion® membranes 22 have been researched. Both provide the mechanical support necessary to create dimensionally stable membranes 22. As described below, Nafion® ionomer or resin is applied to the porous glass or Teflon substrate, through a droplet or spray, or the porous substrate is immersed in Nafion® ionomer. Several coats are generally required to create a membrane without pinholes.

Glass substrates may exhibit superior performance because they are hydrophilic, and thus absorb the ionomer better. Dipping appears to yield better performance than dropping or spraying, especially with the glass substrate. Nafion® saturation can be reached in four dipping operations instead of nine dropping or spraying operations.

One particular method for fabricating membranes 22 is by means of an immersion-hot press system. According to this method, the porous substrate is weighed to determine the initial conditions. The porous substrate is then placed on a stainless steel mesh and dipped in a Nafion® ionomer solution. The dipping time is approximately 30 seconds for the first coat. Every subsequent coat requires an additional 30 seconds of immersion to compensate for the reduction in pore size. The composite membrane 22 is removed from the solution on its steel mesh to ensure that it does not tear. Membrane 22 is then placed on another stainless steel mesh and left to dry at room temperature for approximately 10 to 20 minutes. Subsequently, membrane 22 is placed in an oven for 25 minutes at a temperature of 75° C. to ensure that solvent has been driven off.

During this time a hot press is set to a temperature of 140° C. One or more membranes 22 are placed between clean, chemically inert sheets (e.g. composed of Teflon®) and the combination is placed between two flat and leveled steel plates. The sandwich is placed in the press and pressure is applied. The following Table 1 shows pressure versus coating number.

TABLE 1

| Coating | Pressure |
|---|---|
| 1 | 0.5 ton |
| 2 | 1.0 ton |
| 3+ | 2.0 ton |

Each membrane 22 is then weighed to evaluate the Nafion® loading. The above steps are generally repeated 3 to 5 times to ensure that membrane 22 is completely saturated with Nafion® and all pinholes are removed.

After soaking membrane 22 for several hours in a 10% H₂SO₄ solution, membrane 22 is rinsed with deionized water and soaked in water for another hour. The result of the membrane preparation step is a high conductivity, mechanically robust, dimensionally stable proton exchange membrane 22 that is suitable for subsequent deposition steps. Conductivities of between 1 and 10 mS/cm for Teflon supported membranes 22 and 20 and 52 mS/cm for glass-supported membranes 22 have been measured using standard AC impedance techniques. These results compare favorably to the 78 mS/cm measured for bulk Nafion® during the same experiment.

By way of example, a sample of approximate 12-14 mm length and approximately 10 mm width was removed from a membrane 22 and introduced to an AC impedance test station. To calculate the conductivity the following formula is used:

$$σ = \frac{L}{W \cdot T \cdot R}$$

where

L=distance between the two platinum electrodes in the AC impedance test station

W=width of the piece of membrane being tested

T=thickness of the piece of membrane being tested

R=resistance of the piece of membrane being tested at the lowest value for Z

The following results are indicative for membranes 22 created using the above procedure. Nafion® 117 was characterized using the same apparatus and its conductivity is included for reference.

TABLE 2

| | L | | | | σ | Ratio |
|---|---|---|---|---|---|---|
| Item No. | (cm) | W(cm) | T(cm) | R(Ω) | (Scm⁻¹) | (%) |
| NAFION ® 117 | 0.96 | 1.174 | 0.02 | 524.51 | 0.078 | 100 |
| 030503VTA | 0.96 | 1.164 | 0.01763 | 3844.35 | 0.012 | 16 |
| 030503VTAa | 0.96 | 1.204 | 0.01303 | 3049.85 | 0.020 | 26 |
| 030503VTB | 0.96 | 1.2075 | 0.0166 | 4488.45 | 0.011 | 14 |
| 030503VTBb | 0.96 | 1.0225 | 0.01538 | 3327 | 0.018 | 24 |
| 030503VTC | 0.96 | 1.112 | 0.014125 | 2310.3 | 0.026 | 34 |
| 030503VTD | 0.96 | 1.278 | 0.008 | 2241.55 | 0.042 | 54 |
| 030503VTD1 | 0.978 | 0.875 | 0.01005 | 4090 | 0.027 | 35 |
| 030503VTD3A | 0.96 | 0.999 | 0.007975 | 3050.1 | 0.040 | 51 |
| 030503VTD3B | 0.96 | 0.894 | 0.005075 | 4043 | 0.052 | 67 |
| 040103VTE | 0.96 | 0.970 | 0.01835 | 3039.5 | 0.018 | 23 |
| 040103VTF | 0.96 | 1.064 | 0.01382 | 2236.6 | 0.029 | 37 |
| 041603VTH2 | 0.965 | 1.119 | 0.01320 | 1222.9 | 0.053 | 69 |

Catalyst Deposition

A standard platinum on carbon black catalyst supplied by E-Teck Inc. has been tested. One means for depositing a catalyst layer 24 on membrane 22 is by spraying catalyst ink through a metallic template 34. Steel or nickel templates 34 are suitable for this purpose. Both are magnetic, facilitating good template-membrane contact through a magnetic chuck (FIG. 5(a)). By way of example, 2 mil thick nickel and 1 mil thick steel shim stock may be used. The templates 34 are patterned using micromachining photolithographic techniques. A UV sensitive polymer, known as photoresist, spun onto the templates 34 and patterned with the desired pattern. The pattern is reduced in size by slightly more than the thickness of the metal film to accommodate the expansion of the hole during isotropic etching. The nickel can be etched in 30% FeCl₃ at 60 C for approximately 12 minutes. The steel can also be etched in FeCl₃, and etches completely in 3-4 minutes.

To transfer the catalyst pattern onto a Nation®-impregnated membrane 22, membrane 22 is placed between the nickel template 34 and a flat magnet 38 (FIG. 5(a)). A homogenized Pt/C catalyst in butylacetate solution (10 wt % Pt/C, 20 wt % Nafion®) is subsequently applied on the mask/membrane/magnet setup using an airbrush operated with a compressed air-stream at approximately 50 psi. Spraying is alternated with drying in a room temperature forced air stream to prevent smearing of the catalyst pattern. The setup is rotated periodically with respect to the airbrush to ensure uniformity in the catalyst loading. Once the desired amount of catalyst is deposited, the mask/membrane/magnet system is disassembled, membrane 22 reversed and the setup reassembled for applying the catalyst on the opposite side of membrane 22. Care must be taken to align template 34 on membrane 22 with respect to the catalyst pattern already deposited on the opposite side of membrane 22. This can be easily done with the aid of a light table, for example.

Membrane 22 is weighed before and after applying the catalyst on each side thereof to determine the overall amount of catalyst deposited. By way of typical example, approximately 30 mg of catalyst may be applied to an area of ^{˜}450 mm² area (i.e. one side of membrane 22). In order to achieve such catalysts loading, approximately 20 ml of catalyst is sprayed over the entire area of template 34 (i.e. for each side 29, 30 of membrane 22). After applying the catalyst solution to both sides of membrane 22, membrane 22 can be hot pressed (as discussed above), typically at ^{˜}130 degrees Celsius at 6 metric tonnes (90 mm diameter membrane) to facilitate a better three phase interface.

Current Collection

One possible means for deposition of current collector layer 26 on membrane 22 is by a sputtering process through a metallic template 42. As discussed above, templates 42 are fashioned in the same manner as the catalyst templates 34, with a matched design to provide a minimum reliable overlap between the catalyst and current collector layers 24,26, and a minimum profile for current collector layer 26.

According to this example, template 42 is pre-aligned on coated membrane 22 under a microscope on a flat magnet 38 (FIG. 5(b)). The magnet-MEA-template assembly is then placed inside a sputter coater with a pre-loaded gold target. The gold is deposited on membrane 22 using the following sputterer settings.

| | |
|---|---|
| Target: | Gold |
| Thickness: | 200 nm |
| Voltage: | 2500 VDC |
| Plasma Current: | 20 mA |
| Time: | 16 min |
| Sputter Rates: | 13 nm/mim |

The cell electrodes can then be electrically connected in any parallel or series combination, such as by using a conductive epoxy. The conductive epoxy can be painted between traces to wire the cell in parallel, or in conjunction with short pieces of wire, be used to wire the cell in series. The two-part silver epoxy is mixed in a small quantity with a one-to-one ratio then painted on the cell. The epoxy is then cured for 15 minutes at 70 C, or left to cure overnight at room temperature.

Flow Channel Fabrication

Many metals, ceramics and plastics have the necessary thermal and chemical stability to serve as flow channels. The materials can be cast, injection molded or embossed. By way of example, silicone rubber has been shown to be a suitable material for formation of flow channel layer 28. Our preferred method for small runs is casting into a single sided mold 47 (FIG. 6), but injection molding or embossing would likely be preferred for mass production. Injection molds or embossing irons can be etched photolithographically, or machined using a combination of laser micromachined graphite, and plunge electrodischarge machining.

Single-sided molds 47 for casting have been produced using photolithographic techniques. In this example, SU-8, a high aspect ratio UV curable epoxy, was used to form the casting mold. As described above, the SU-8 was spun on a flat substrate such as a silicon wafer or glass plate at ^{˜}700 rpm for 30 seconds. After a short period where the film is allowed to relax, it is placed in an oven at 100° C. for approximately 2 hours. The film should be hard to the touch after cooling. The film is then exposed to UV light through an emulsion mask with the desired pattern. The film is exposed four consecutive times for 45 seconds, with a 15 second break between exposures. The film is then baked again at 100° C. for 15 minutes. The film is developed in SU-8 developer at room temperature for approximately 1 hour with gentle agitation. The mold 47 is then cleaned with new developer.

The flow fields are cast directly onto mold 47 using Dow Corning mold making silicone rubber. Other castable materials are possible, but Dow Corning 3110 RTV Rubber with Catalyst 1 has been shown to be effective. The catalyst and compound are mixed using the suggested process of the manufacturer, using a 20 to 1 ratio. Gentle mixing is required to avoid embedded bubbles in the mixture. The mixture is poured over the mold approximately 2 mm deep on a clean level surface. After 12 hours of curing time, the cast flow fields can be removed by hand, and any excess rubber cut away.

Sealing the flow field layer 28 to membrane 22 is accomplished using standard silicone rubber adhesive. The adhesive can be painted directly onto flow field layer 28, or can be spread in a thin layer on a flat substrate, and roll the flow fields over the film like a stamp. Once the adhesive has been applied, the flow field layer is affixed on membrane 22 by applying modest pressure. The silicone is then allowed to dry for 12 hours.

Alternatively, the flow fields can be created directly on membrane 22 using SU-8 as described above.

A micro fuel cell 20 fabricated as described above is shown, for example, in FIG. 3(d).

Fuel Cell Test Polarization and Power Results

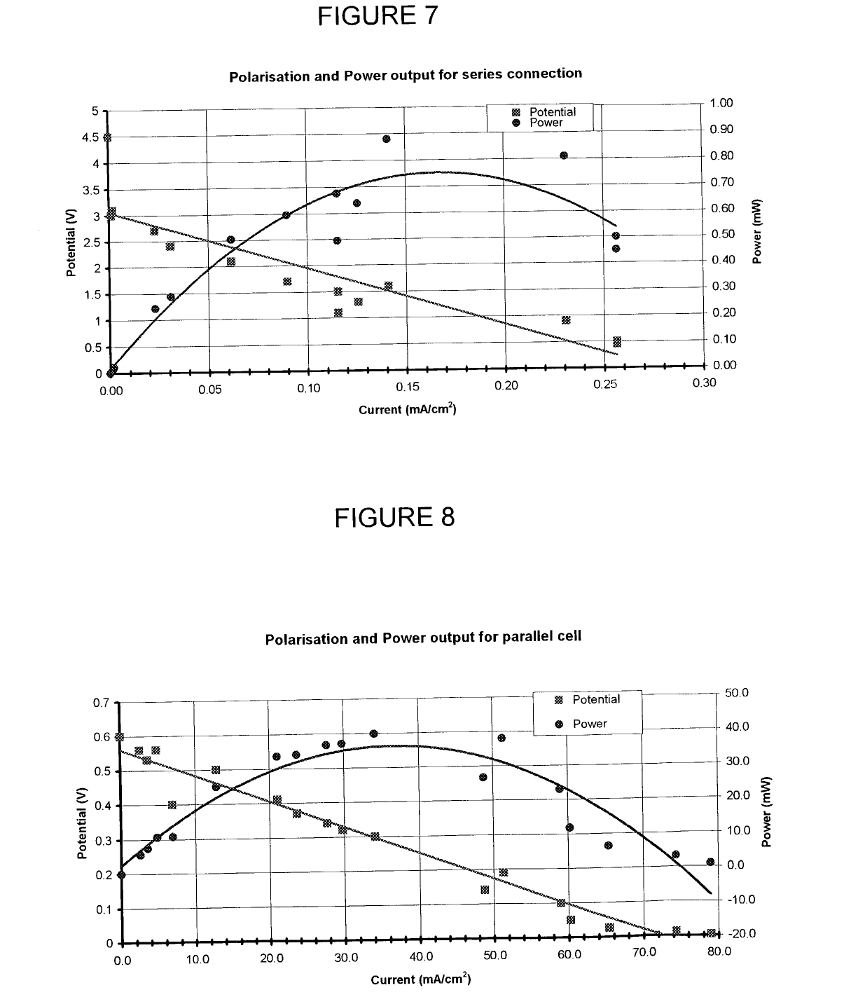

FIGS. 7 and 8 are graphs showing polarization and power data for fuel cells fabricated in accordance with the invention. In one design, a fuel cell as in the embodiment of FIG. 3(a) was fabricated with 13 electrodes electrically connected in series. Each electrode had dimensions of 1.2 mm width by 30 mm length, and the electrodes were spaced 1.2 mm apart. The gold current collectors had widths of 0.4 mm, and they overlapped the electrodes by 0.2 mm. Preliminary testing and evaluation of this fuel cell at room temperature with 1 atm H₂ and 1 atm air yielded the polarization and power data as illustrated in FIG. 7. The open-cell voltage was 4.5 V, and the peak power was approx. 0.8 mW.

In another design, a fuel cell was fabricated as in FIG. 4(a) with 15 electrodes electrically connected in parallel. Each electrode had dimensions of 1 mm width by 30 mm length, and the electrodes were spaced 1 mm apart. The gold current collectors had widths of 1 mm, and they overlap the electrodes by 0.2 mm. Preliminary testing and evaluation of this fuel cell at R.T. with 1 atm H2 and 1 atm air yielded the polarization and power data as depicted in FIG. 8. The open-cell voltage was 0.6 V, and the peak power was approximately 37 mW.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of fabricating a membrane electrode assembly comprising:
(a) providing a dimensionally stable membrane having a first surface and a second surface;
(b) depositing a first catalyst layer on said first surface according to a first predetermined pattern; and
(c) depositing a first current collector layer on said first surface according to a second predetermined pattern.

2. The method as defined in claim 1, wherein said first and second predetermined patterns are aligned such that said catalyst layer and said current collector layer are in contact with one another on said membrane.

3. The method as defined in claim 1, wherein said first and second predetermined patterns are aligned such that said catalyst layer and said current collector layer are applied in a generally common plane of deposition in contact with one another on said membrane.

4. The method as defined in claim 2, wherein said first predetermined pattern divides said catalyst layer into a plurality of discrete catalyst regions and wherein said second predetermined pattern divides said current collection layer into a plurality of discrete conductive regions, wherein each of said conductive regions is in electrical connection with and located immediately adjacent to a corresponding one of said catalyst regions on said membrane.

5. The method as defined in claim 4, wherein each of said conductive regions comprises a distinct electrode.

6. The method as defined in claim 5, further comprising electrically connecting said electrodes together.

7. The method as defined in claim 1, further comprising:
(c) depositing a second catalyst layer on said second surface of said membrane according to said first predetermined pattern; and
(d) depositing a second current collector layer on said second surface of said membrane according to said second predetermined pattern.

8. The method as defined in claim 7, wherein said first predetermined pattern on said first surface of said membrane is aligned with said first predetermined pattern on said second surface of said membrane, and wherein said second predetermined pattern on said first surface of said membrane is aligned with said second predetermined pattern on said second surface of said membrane.

9. The method as defined in claim 1, wherein said membrane is a proton exchange membrane.

10. The method as defined in claim 9, wherein said step of providing a dimensionally stable membrane comprises:
(a) providing a porous substrate composed of an inert material selected from the group consisting of glass, polytetrafluoroethylene, polyethylene, and polypropylene; and
(b) impregnating said substrate with an ionomer.

11. The method as defined in claim 10, wherein said ionomer is Nafion®.

12. The method as defined in claim 1, wherein the step of depositing said catalyst layer on said first surface according to said first predetermined pattern comprises:
(a) providing a first template having openings corresponding to said first predetermined pattern;
(b) temporarily coupling said first template to said membrane; and
(c) spraying a catalyst through said openings in said first template to deposit said catalyst on said membrane in said first predetermined pattern.

13. The method as defined in claim 12, wherein said first template is temporarily coupled to said membrane by interposing said membrane between said template and a magnet.

14. The method as defined in claim 1, wherein the step of depositing said catalyst layer on said first surface according to said first predetermined pattern comprises applying said catalyst to said membrane and patterning said catalyst by photolithography.

15. The method as defined in claim 1, wherein the step of depositing said catalyst layer on said first surface according to said first predetermined pattern comprises printing said catalyst directly on said membrane.

16. The method as defined in claim 1, wherein said catalyst layer is deposited on said membrane by means of a mechanical applicator contacting said membrane.

17. The method as defined in claim 1, further comprising hot pressing said membrane electrode assembly.

18. The method as defined in claim 1, wherein the step of depositing said current collector layer on said first surface according to said second predetermined pattern comprises:
(a) providing a second template having openings corresponding to said second predetermined pattern;
(b) temporarily coupling said second template to said membrane; and
(c) depositing a conductor through said openings in said second template to deposit said conductor directly on said membrane in said second predetermined pattern.

19. The method as defined in claim 18, wherein said second template is temporarily coupled to said membrane by interposing said membrane between said second template and a magnet.

20. The method as defined in claim 1, wherein the step of depositing said current conductor layer on said first surface according to said second predetermined pattern comprises applying said current conductor to said membrane and patterning said current conductor by photolithography.

21. The method as defined in claim 1, wherein the step of depositing said current conductor layer on said first surface according to said second predetermined pattern comprises printing said current conductor layer directly on said membrane.

22. The method as defined in claim 1, wherein said current conductor layer is deposited on said membrane by means of a mechanical applicator contacting said membrane.

23. A method of fabricating a fuel cell comprising:
(a) providing a dimensionally stable membrane having a first surface and a second surface;
(b) depositing a first catalyst layer on said first surface according to a first predetermined pattern;
(c) depositing a first current collector layer on said first surface according to a second predetermined pattern; and
(d) forming a first flow field layer on said membrane according to a third predetermined pattern, wherein at least a portion of said flow field layer is bonded to said membrane.

24. The method as defined in claim 23, wherein said first and second predetermined patterns are aligned such that said catalyst layer and said current collector layer are in contact with one another on said membrane.

25. The method as defined in claim 23, wherein said first and second predetermined patterns are aligned such that said catalyst layer and said current collector layer are applied in a generally common plane of deposition in contact with one another on said membrane.

26. The method as defined in claim 24, wherein said first predetermined pattern divides said catalyst layer into a plurality of discrete catalyst regions and wherein said second predetermined pattern divides said current collection layer into a plurality of discrete conductive regions, wherein each of said conductive regions is in electrical connection with and located immediately adjacent to a corresponding one of said catalyst regions on said membrane.

27. The method as defined in claim 26, wherein each of said conductive regions comprises a distinct electrode.

28. The method as defined in claim 27, further comprising electrically connecting said electrodes together.

29. The method as defined in claim 23, wherein said step of forming said first flow field layer on said membrane comprises:
(a) applying a curable epoxy to said membrane; and
(b) allowing said epoxy to cure in said third predetermined pattern.

30. The method as defined in claim 29, wherein said epoxy is SU-8.

31. The method as defined in claim 26, wherein said flow field layer comprises at least one flow field channel formed adjacent said discrete catalyst regions.

32. The method as defined in claim 31, wherein at least a portion of said flow field layer overlaps said conductive regions.

33. The method as defined in claim 23, wherein said step of forming said first flow field layer on said membrane comprises:
(a) casting said first flow field layer in said third predetermined pattern; and
(b) adhering said first flow field layer to said membrane.

34. The method as defined in claim 23, further comprising:
(c) depositing a second catalyst layer on said second surface of said membrane according to said first predetermined pattern; and
(d) depositing a second current collector layer on said second surface of said membrane according to said second predetermined pattern; and
(e) forming a second flow field layer on said second surface of said membrane.

35. The method as defined in claim 34, wherein said first predetermined pattern on said first surface of said membrane is aligned with said first predetermined pattern on said second surface of said membrane, and wherein said second predetermined pattern on said first surface of said membrane is aligned with said second predetermined pattern on said second surface of said membrane.

36. The method as defined in claim 23, wherein said membrane is a proton exchange membrane.

37. The method as defined in claim 36, wherein said step of providing a dimensionally stable membrane comprises:
(a) providing a porous substrate composed of an inert material selected from the group consisting of glass polytetrafluoroethylene, polyethylene, and polypropylene; and
(b) impregnating said substrate with an ionomer.

38. The method as defined in claim 37, wherein said ionomer is Nafion®.

39. The method as defined in claim 23, wherein the step of depositing said catalyst layer on said first surface according to said first predetermined pattern comprises:
(a) providing a first template having openings corresponding to said first predetermined pattern;
(b) temporarily coupling said first template to said membrane; and
(c) spraying a catalyst through said openings in said first template to deposit said catalyst on said membrane in said first predetermined pattern.

40. The method as defined in claim 39, wherein said first template is temporarily coupled to said membrane by interposing said membrane between said template and a magnet.

41. The method as defined in claim 23, wherein the step of depositing said catalyst layer on said first surface according to said first predetermined pattern comprises applying said catalyst to said membrane and patterning said catalyst by photolithography.

42. The method as defined in claim 23, wherein the step of depositing said catalyst layer on said first surface according to said first predetermined pattern comprises printing said catalyst directly on said membrane.

43. The method as defined in claim 23, wherein said catalyst layer is deposited on said membrane by means of a mechanical applicator contacting said membrane.

44. The method as defined in claim 23, further comprising hot pressing said membrane electrode assembly.

45. The method as defined in claim 23, wherein the step of depositing said current collector layer on said first surface according to said second predetermined pattern comprises:
(a) providing a second template having openings corresponding to said second predetermined pattern;
(b) temporarily coupling said second template to said membrane; and
(c) sputtering a conductor through said openings in said second template to deposit said conductor directly on said membrane in said second predetermined pattern.

46. The method as defined in claim 44, wherein said second template is temporarily coupled to said membrane by interposing said membrane between said second template and a magnet.

47. The method as defined in claim 23, wherein the step of depositing said current conductor layer on said first surface according to said second predetermined pattern comprises applying said current conductor to said membrane and patterning said current conductor by photolithography.

48. The method as defined in claim 23, wherein the step of depositing said current conductor layer on said first surface according to said second predetermined pattern comprises printing said current conductor layer directly on said membrane.

49. The method as defined in claim 23, wherein said current conductor layer is deposited on said membrane by means of a mechanical applicator contacting said membrane.

50. A method of fabricating a fuel cell comprising:
(a) forming first and second membrane electrode assemblies in accordance with the method defined in claim 1; and
(b) annealing said second surface of said first membrane assembly to said second surface of said second membrane assembly.

51. The method as defined in claim 50, wherein said second surfaces are coated with Nafion® prior to annealing said surfaces together.

52. A method of fabricating a fuel cell comprising:
(a) fabricating a membrane electrode assembly as defined in claim 1; and
(b) bonding a flow field layer to said membrane electrode assembly.

53. A membrane electrode assembly fabricated by the method of claim 1.

54. A fuel cell fabricated by the method of claim 23.

55. A membrane electrode assembly comprising:
(a) a dimensionally stable proton exchange membrane having first and second sides;
(b) a catalyst layer applied directly on said membrane; and
(c) a current collecting layer applied directly on said membrane in contact with said catalyst layer.

56. The assembly as defined in claim 55, wherein said assembly has a thickness less than 1 mm.

57. The assembly as defined in claim 55, wherein said catalyst layer and said current collecting layer are applied to both of said first and second sides of said membrane.

58. The assembly as defined in claim 55, wherein said first surface comprises an anode side of said membrane and said second surface comprises a cathode side of said membrane.

59. The assembly as defined in claim 55, wherein said catalyst layer and said current collecting layer are generally co-planar.

60. The assembly as defined in claim 55, wherein said assembly is flexible.

61. The assembly as defined in claim 55, wherein said membrane comprises a composite of an ionomer impregnated in a porous substrate.

62. The assembly as defined in claim 61, wherein said substrate hydrophilic.

63. A fuel cell comprising:
(a) a dimensionally stable proton exchange membrane having first and second sides;
(b) a catalyst layer applied directly on said membrane;
(c) a current collecting layer applied directly on said membrane in contact with said catalyst layer; and
(d) a flow field layer bonded to said membrane comprising at least one channel for delivering reactants to and removing reactants from said fuel cell.

64. The fuel cell as defined in claim 63, wherein said fuel cell is flexible.

65. The fuel cell as defined in claim 63, wherein said fuel cell has a thickness less than 5 mm.

66. A fuel cell stack comprising a plurality of fuel cells as defined in claim 63.

67. The fuel cell stack of claim 66 wherein said flow field layer is applied to said first side of said membrane of each of said fuel cells and wherein said stack is formed by bonding said flow field layer of one of said fuel cells to said flow field layer of another one of said fuel cells.

68. The fuel cell stack of claim 67, wherein said first side is the anode side of said fuel membrane.
